(19) United States
(12) Patent Application Publication
(10) Pub. No.: US 2013/0249500 A1
(43) Pub. Date: Sep. 26, 2013

(54) ELECTRONIC DEVICE AND METHOD FOR CHARGING ELECTRONIC DEVICE

(71) Applicant: QUAN HE, Shenzhen City (CN)

(72) Inventor: QUAN HE, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/613,249

(22) Filed: Sep. 13, 2012

(30) Foreign Application Priority Data
Mar. 23, 2012 (CN) 201210078976.1

(51) Int. Cl. H02J 7/00

(52) U.S. Cl. 320/162

(57) ABSTRACT

In a method for charging an electronic device, the method increases a charging current value of a battery of the electronic device by a preset charging current increment, and compares a current value of the charging current with a maximum charging current value of the battery if the value of the voltage across a universal serial bus (USB) interface of the electronic device is greater than the preset voltage value. The method controls the battery of the electronic device charge from a power supply equipment by setting the maximum charging current value as the value of the charging current, if the charging current value is not less than the maximum charging current value.

### BACKGROUND

1. Technical Field

Embodiments of the present disclosure relate to charging systems and methods, and more particularly to an electronic device, a storage medium, and a method for charging the electronic device.

2. Description of Related Art

Electronic devices are typically charged through a universal serial bus (USB) 2.0 interface. However, a single USB 2.0 interface is only limited to 500 mA of charging current when charging an electronic device through the USB 2.0 interface. With the increase of battery capacity of these electronic device, the maximum charging current the battery can withstand is increasing. In order to improve the power capacity, a USB 3.0 interface is beginning to be used for charging. The charging current inputted through the USB 3.0 interface can reach 900 mA, but the electronic device may not be able to recognize the USB 3.0 interface and thus limits the charging current to only be 500 mA using the present charging system, which reduces the charging efficiency.

### BRIEF DESCRIPTION OF THE DRAWINGS

FIG. 1 is a block diagram of one embodiment of an electronic device including a charging system.

FIG. 2 is a block diagram of one embodiment of function modules of the charging system in FIG. 1.

FIG. 3 is a flowchart of one embodiment of a method for charging an electronic device.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some non-limiting examples of non-transitory computer-readable media include CDs, DVDs, BLU-RAY, flash memory, and hard disk drives.

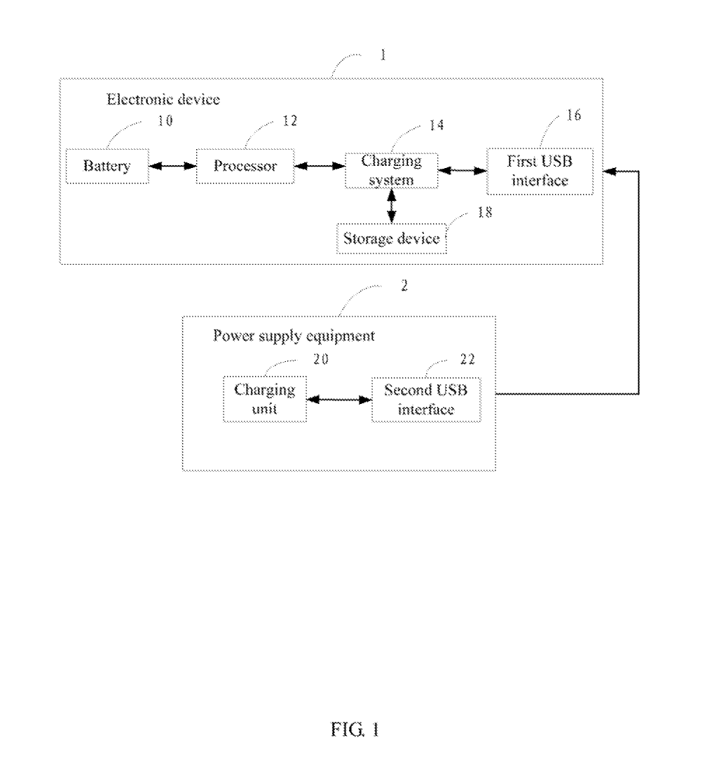

FIG. 1 is a block diagram of one embodiment of an electronic device 1 including a charging system 14. In the embodiment, the electronic device 1 further includes a battery 10, at least one processor 12, a first universal serial bus (USB) interface 16, and a storage device 18. The electronic device 1 is electrically connected to a power supply equipment 2 through the first USB interface 16 when the electronic device 1 is charged from the power supply equipment 2. In one embodiment, the power supply equipment 2 can be a computer including a second USB interface 22 and a charging unit 20. The electronic device 1 may be a cell phone, a mobile device, or a personal digital assistant (PDA) device.

The batter 10 provides power for the electronic device 1, and can be charged by the charging unit 20 of the power supply equipment 2 through the first USB interface 16. The first USB interface 16 is connected to the second USB interface 22 when the batter 10 of the electronic device 1 is charged by the charging unit 20 of the power supply equipment 2.

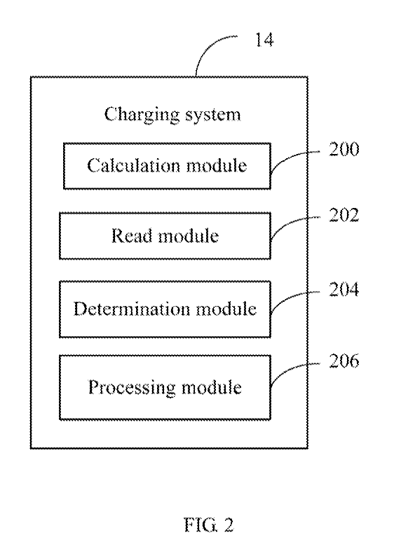

In one embodiment, the charging system 14 includes a plurality of function modules (see FIG. 2 below), which include one or more program in the form of computerized codes that are stored in the storage device 18 and executed by the processor 12, to provide a charging function of the electronic device 1.

The storage device 18 may include any type(s) of non-transitory computer-readable storage medium, such as a hard disk drive, a compact disc, a digital video disc, or a tape drive. The storage device 18 stores the computerized code of the function modules of the charging system 14. The at least one processor 12 may be a processor unit, a microprocessor, an application-specific integrated circuit (ASIC), or a field programmable gate array (FPGA).

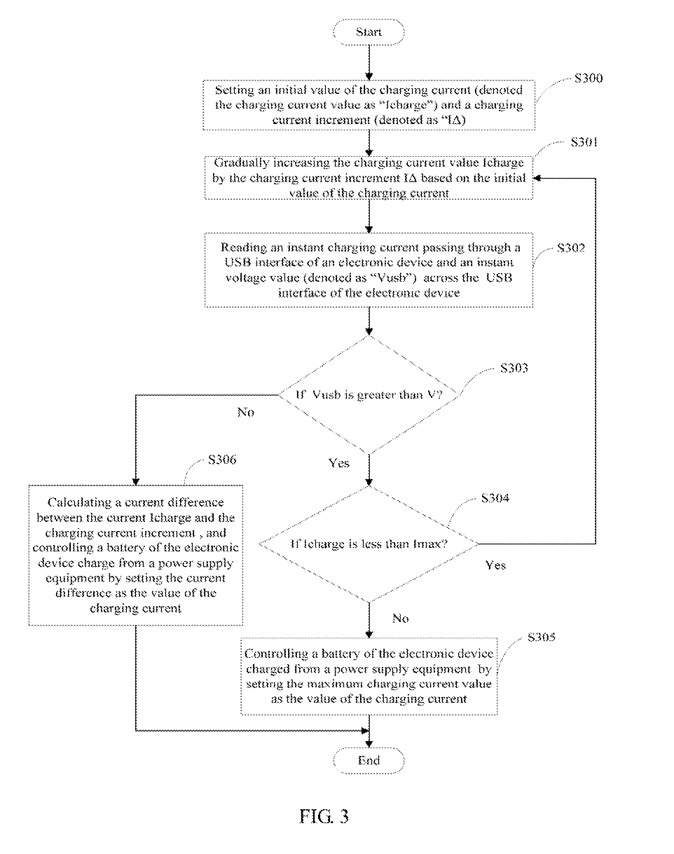

FIG. 2 is a block diagram of one embodiment of the function modules of the charging system 14. In the embodiment, the charging system 14 may include a calculation module 200, a read module 202, a determination module 204, and a processing module 206. The functions of the function modules 200-206 are illustrated in FIG. 3 and described below.

FIG. 3 illustrates a flowchart of one embodiment of a method for charging the electronic device 1. Depending on the embodiment, additional steps may be added, others removed, and the ordering of the steps may be changed.

In step S300, the calculation module 200 sets an initial value of a charging current (denoted the charging current value as “Icharge”) of the battery 10, and sets a charging current increment (denoted as “ΔI”) for charging the electronic device 1. For example, the calculation module 200 may set the initial value of the charging current as 400 mA, and set the charging current increment as 10 mA.

In step S301, the calculation module 200 gradually increases the charging current value Icharge by the charging current increment ΔI based on the initial value of the charging current.

In step S302, the read module 202 reads an instant charge current passing through the first USB interface 16, and reads an instant voltage value (denoted as “Vusb”) of the first USB interface 16, which is a voltage across the first USB interface 16.

In step S303, the determination module 204 compares a current voltage value Vusb with a preset voltage value (denoted as “V”) to determine if Vusb is greater than V during the increasing process of the charging current value Icharge. The preset voltage value V is preset as the minimum voltage value for the first USB interface 16 to work normally. If Vusb is greater than V, step S304 is implemented. Otherwise, if Vusb is not greater than V, step S306 is implemented.

In step S304, the determination module 204 compares a current value of Icharge with a maximum charging current value (denoted as “Imax”) of the battery 10 to determine if Icharge is less than Imax. If Icharge is less than Imax, step S301 is repeated. Otherwise, if Icharge is not less than Imax, step S305 is implemented.

In step S305, the processing module 206 controls the battery 10 of the electronic device 1 charge from the charging unit 20 of the power supply equipment 2 by setting the maximum charging current value Imax as the value of the charging current.

In step S306, the processing module 206 calculates a current difference between the current Icharge and the charging current increment ΔI, and controls the battery 10 of the electronic device 1 charge from the charging unit 20 of the power supply equipment 2 by setting the current difference as the value of the charging current.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device connected to a power supply equipment, the electronic device comprising:
a battery;
a universal serial bus (USB) interface;
a storage device;
at least one processor; and
one or more programs being stored in the storage device and executable by the at least one processor, the one or more programs comprising:
a calculation module that sets an initial value of a charging current of the battery and a charging current increment, and gradually increases the charging current value by the charging current increment based on the initial value of the charging current;
a read module that reads an instant charge current passing through the USB interface of the electronic device, and reads an instant value of a voltage across the USB interface of the electronic device;
a determination module that compares a value of the voltage across the USB interface of the electronic device with a preset voltage value, and compares a current value of the charging current with a maximum charging current value of the battery if the value of the voltage across the USB interface of the electronic device is greater than the preset voltage value; and
a processing module that controls the battery charge from the power supply equipment by setting the maximum charging current value as the value of the charging current, if the charging current value is not less than the maximum charging current value.

2. The electronic device according to claim 1, wherein the preset voltage value is the minimum voltage value for the USB interface of the electronic device to work normally.

3. The electronic device according to claim 1, wherein the processing module further calculates a current difference between the current value of the charging current and the charging current increment.

4. The electronic device according to claim 3, wherein the processing module further controls the battery of the electronic device charge from the charging unit of the power supply equipment by setting the current difference as the value of the charging current, if the value of the voltage across the USB interface of the electronic device is not greater than the preset voltage value.

5. The electronic device according to claim 1, wherein the calculation module sets the initial value of the charging current as 400 mA.

6. The electronic device according to claim 1, wherein the calculation module sets the value of the charging current increment as 10 mA.

7. The electronic device according to claim 1, wherein the electronic device is a cell phone, a mobile device, or a personal digital assistant (PDA) device.

8. A method for a charging an electronic device connected to a power supply equipment, the method comprising:
setting an initial value of a charging current of a battery of the electronic device, and setting a charging current increment;
increasing the charging current value by the charging current increment based on the initial value of the charging current;
reading an instant charge current passing through a universal serial bus (USB) interface of the electronic device, and reading an instant value of a voltage across the USB interface of the electronic device;
comparing a value of the voltage across the USB interface of the electronic device with a preset voltage value;
comparing a current value of the charging current with a maximum charging current value of the battery if the value of the voltage across the USB interface of the electronic device is greater than the preset voltage value; and
controlling the battery of the electronic device charge from the power supply equipment by setting the maximum charging current value as the value of the charging current, if the charging current value is not less than the maximum charging current value.

9. The method according to claim 8, wherein the preset voltage value is the minimum voltage value for the USB interface of the electronic device to work normally.

10. The method according to claim 8, further comprising:
calculating a current difference between the current value of the charging current and the charging current increment.

11. The method according to claim 10, further comprising:
controlling the battery of the electronic device charge from the power supply equipment by setting the current difference as the value of the charging current, if the value of the voltage across the USB interface of the electronic device is not greater than the preset voltage value.

12. The method according to claim 8, wherein the initial value of the charging current is set as 400 mA.

13. The method according to claim 8, wherein the value of the charging current increment is set as 10 mA.

14. The method according to claim 8, wherein the electronic device is a cell phone, a mobile device, or a personal digital assistant (PDA) device.

15. A non-transitory computer-readable storage medium having stored thereon instructions capable of being executed by a processor of an electronic device, causes the processor to perform a method for charging the electronic device, the method comprising:
setting an initial value of a charging current of a battery of the electronic device, and setting a charging current increment;
increasing the charging current value by the charging current increment based on the initial value of the charging current;
reading an instant charge current passing through a universal serial bus (USB) interface of the electronic device, and reading an instant value of a voltage across the USB interface of the electronic device;
comparing a value of the voltage across the USB interface of the electronic device with a preset voltage value;
comparing a current value of the charging current with a maximum charging current value of the battery if the value of the voltage across the USB interface of the electronic device is greater than the preset voltage value; and
controlling the battery of the electronic device charge from the power supply equipment by setting the maximum charging current value as the value of the charging current, if the charging current value is not less than the maximum charging current value.

16. The storage medium according to claim 15, wherein the preset voltage value is the minimum voltage value for the USB interface of the electronic device to work normally.

17. The storage medium according to claim 15, wherein the method further comprises:
calculating a current difference between the current value of the charging current and the charging current increment.

18. The storage medium according to claim 17, wherein the method further comprises:
controlling the battery of the electronic device charge from the power supply equipment by setting the current difference as the value of the charging current, if the value of the voltage across the USB interface of the electronic device is not greater than the preset voltage value.

19. The storage medium according to claim 15, wherein the initial value of the charging current is set as 400 mA.

20. The storage medium according to claim 15, wherein the value of the charging current increment is set as 10 mA.

21. The storage medium according to claim 15, wherein the electronic device is a cell phone, a mobile device, or a personal digital assistant (PDA) device.
